(19) United States
(12) Patent Application Publication
(10) Pub. No.: US 2025/0031093 A1
(43) Pub. Date: Jan. 23, 2025

(54) METHOD AND APPARATUS FOR WIRELESS COMMUNICATION

(71) Applicant: LENOVO (BEIJING) LIMITED, Beijing (CN)

(72) Inventors: Yibin Zhuo, Shanghai (CN); Mingzeng Dai, Shanghai (CN); Haiyan Luo, Shanghai (CN); Jing Han, Beijing (CN); Lianhai Wu, Beijing (CN); Le Yan, Shanghai (CN)

(21) Appl. No.: 18/711,283

(22) PCT Filed: Nov. 19, 2021
(86) PCT No.: PCT/CN2021/131801

§ 371 Date: May 17, 2024

(51) Int. Cl. H04W 28/02; H04W 72/1268

(52) U.S. Cl. CPC H04W 28/0278; H04W 72/1268

(57) ABSTRACT

Embodiments of the present disclosure relate to a method and apparatus for wireless communication. According to some embodiments of the disclosure, a UE may detect uplink data with a first importance level becoming available to a medium access control (MAC) entity of the UE, wherein the first importance level may identify the relative importance information of the uplink data. The UE may trigger buffer status reporting (BSR) in response to the first importance level satisfying a criterion for triggering the BSR.

### TECHNICAL FIELD

Embodiments of the present disclosure generally relate to wireless communication technology, and more particularly to processing traffic in a wireless system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Extended reality (XR) is an umbrella term for different types of realities, including for example, virtual reality (VR), augmented reality (AR) and mixed reality (MR). XR may refer to all real-and-virtual combined environments and human-machine interactions generated by computer technology and wearables. It may include representative forms such as AR, MR and VR and the areas interpolated among them. The levels of virtuality range from partially sensory inputs to fully immersive VR. A key aspect of XR is the extension of human experiences especially relating to the senses of existence (represented by VR, for example) and the acquisition of cognition (represented by AR, for example).

It is desirable to integrate XR applications into a wireless communication system such as a 5G system. There is a need for handling XR traffic in a wireless communication system.

### SUMMARY

Some embodiments of the present disclosure provide a user equipment (UE). The UE may include: a transceiver; and a processor coupled to the transceiver. The processor may be configured to: detect uplink data with a first importance level becoming available to a medium access control (MAC) entity of the UE, wherein the first importance level identifies the relative importance of the uplink data; and trigger buffer status reporting (BSR) based on the uplink data. The uplink data may be associated with a logical channel belonging to a logical channel group (LCG) of the UE.

In some embodiments of the present disclosure, the transceiver may be configured to receive an uplink grant for transmitting uplink data buffered at the UE in response to the BSR. The processor may be further configured to perform a logical channel prioritization (LCP) procedure to allocate resources configured by the uplink grant to the uplink data.

In some embodiments, to perform the LCP procedure, the processor may be further configured to: (a) select a logical channel (LCH) with a highest priority and transmittable data amount being greater than zero among all LCHs having uplink data available for transmission; and (b) preferentially allocate a resource configured by the uplink grant to a data packet with an importance level in the selected LCH. In some examples, to allocate a resource to a data packet with an importance level in the selected LCH, the processor may be further configured to allocate resources configured by the uplink grant to data packets with respective importance levels in a decreasing importance level order. To perform the LCP procedure, the processor may be further configured to: (c) in response to any resource configured by the uplink grant remaining and the transmittable data amount of the selected LCH being greater than zero, allocate a resource configured by the uplink grant to a data packet without an importance level in the selected LCH. To perform the LCP procedure, the processor may be further configured to: (d) decrement the transmittable data amount of the selected LCH by the size of the data packets in the selected LCH which have been allocated with resources; and perform steps (a)-(d) for remaining LCHs in a decreasing priority order.

In some embodiments, to perform the LCP procedure, the processor may be further configured to allocate resources configured by the uplink grant to data packets with respective importance levels among all logical channels (LCHs) in a decreasing importance level order. To perform the LCP procedure, the processor may be further configured to decrement a transmittable data amount of an LCH by the size of the data packets with the respective importance levels in the LCH which have been allocated with resources.

Some embodiments of the present disclosure provide a user equipment (UE). The UE may include: a transceiver; and a processor coupled to the transceiver. The transceiver may be configured to receive a radio resource control (RRC) message configuring a quality of service (QOS) flow-to-data radio bearer (DRB) mapping rule, wherein the mapping rule maps a first QoS flow to at least one DRB. The processor may be configured to map an uplink packet for the first QoS flow to a DRB according to the mapping rule.

In some embodiments of the present disclosure, the mapping rule may map a first importance level and a second importance level associated with the first QoS flow to different DRBs of the at least one DRB. In some embodiments of the present disclosure, the mapping rule may map each importance level associated with the first QoS flow to only one respective DRB of the at least one DRB. In some embodiments of the present disclosure, the mapping rule may map the same importance level associated with different QoS flows to the same DRB of the at least one DRB. In some embodiments of the present disclosure, the mapping rule may map QoS flows to DRBs according to importance levels associated with the QoS flows.

Some embodiments of the present disclosure provide a base station (BS). The BS may include: a processor; and a transceiver coupled to the processor. The transceiver may be configured to: receive, from a user equipment (UE), buffer status reporting (BSR), wherein the BSR includes an importance field; and transmit an uplink grant to the UE based on the importance field of the BSR. The BSR may correspond to a BSR medium access control (MAC) control element (CE) of the UE.

Some embodiments of the present disclosure provide a base station (BS). The BS may include: a processor; and a transceiver coupled to the processor. The transceiver may be configured to: transmit, to a user equipment (UE), a radio resource control (RRC) message configuring a quality of service (QOS) flow-to-data radio bearer (DRB) mapping rule, wherein the mapping rule maps a first QoS flow to at least one DRB associated with the UE; and receive an uplink packet for the first QoS flow according to the mapping rule.

In some embodiments of the present disclosure, the mapping rule may a first importance level and a second importance level associated with the first QoS flow to different DRBs of the at least one DRB. In some embodiments of the present disclosure, the mapping rule may each importance level associated with the first QoS flow to only one respective DRB of the at least one DRB. In some embodiments of the present disclosure, the mapping rule may the same importance level associated with different QoS flows to the same DRB of the at least one DRB. In some embodiments of the present disclosure, the mapping rule may QoS flows to DRBs according to importance levels associated with the QoS flows.

Some embodiments of the present disclosure provide a method performed by a user equipment (UE). The method may include: detecting an uplink data with a first importance level becoming available to a medium access control (MAC) entity of the UE, wherein the first importance level identifies the relative importance of the uplink data; and triggering buffer status reporting (BSR) based on the uplink data.

Some embodiments of the present disclosure provide a method performed by a user equipment (UE). The method may include: receiving a radio resource control (RRC) message configuring a quality of service (QOS) flow-to-data radio bearer (DRB) mapping rule, wherein the mapping rule maps a first QoS flow to at least one DRB; and mapping an uplink packet for the first QoS flow to a DRB according to the mapping rule.

Some embodiments of the present disclosure provide a method performed by a base station. The method may include: receiving, from a user equipment (UE), buffer status reporting (BSR), wherein the BSR includes an importance field; and transmitting an uplink grant to the UE based on the importance field of the BSR.

Some embodiments of the present disclosure provide a method performed by a base station. The method may include: transmitting, to a user equipment (UE), a radio resource control (RRC) message configuring a quality of service (QOS) flow-to-data radio bearer (DRB) mapping rule, wherein the mapping rule maps a first QoS flow to at least one DRB associated with the UE; and receiving an uplink packet for the first QoS flow according to the mapping rule.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present application provide a technical solution for processing XR traffic, which can facilitate and improve the implementation of various communication technologies.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2 and 3 illustrate exemplary BSR MAC CE formats in accordance with some embodiments of the present disclosure;

FIG. 4 illustrates a flow chart of an exemplary procedure of wireless communications in accordance with some embodiments of the present disclosure;

FIG. 5 illustrates a flow chart of an exemplary procedure of wireless communications in accordance with some embodiments of the present disclosure;

FIG. 6 illustrates a flow chart of an exemplary procedure of wireless communications in accordance with some embodiments of the present disclosure;

FIG. 7 illustrates a flow chart of an exemplary procedure of wireless communications in accordance with some embodiments of the present disclosure; and

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

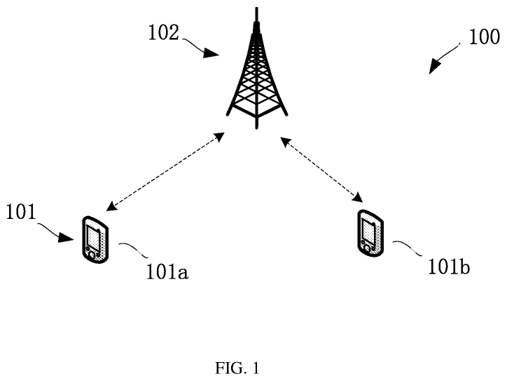

FIG. 1 illustrates a schematic diagram of a wireless communication system 100 in accordance with some embodiments of the present disclosure.

As shown in FIG. 1, a wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In some embodiments of the present disclosure, the wireless communication system 100 may support XR applications. In some embodiments, for an XR IP packet within a quality of service (QOS) flow, a parameter named “importance” may be employed to indicate the importance level of the packet.

For example, according to 3GPP technical report (TR) 26.926, the Internet Protocol (IP) packets for XR traffic may include the following parameters:

TABLE 1
Parameters for the IP packets of XR traffic

| Name | Type | Semantics |
|---|---|---|
| number | BIGINT | Unique packet number in the delivery |

Baseline parameters

| | | |
|---|---|---|
| availabil- | BIGINT | Availability time of packet for next processing |
| ity_time | | step relative to start time 0 in microseconds (0 |
| | | means lost). |
| size | BIGINT | Packet size in bytes. |
| flow_id | BIGINT | An ID of the flow in order to differentiate |
| | | different QoS flows |

Cross-Layer Parameter

| | | |
|---|---|---|
| buffer | BIGINT | The associated eye buffer 1 = left 2 = right |
| | | In general, differentiates application traffic for |
| | | different buffers, for example audio, video, left |
| | | eye, right eye. |
| delay | BIGINT | Delay observed of the packet in the last |
| | | processing step (−1 means lost) |
| render_tim- | BIGINT | The rendering generation timing associated with |
| ing | | the media included in the packet. |
| num- | BIGINT | The number of the packet within the unit (slice), |
| ber_in_unit | | start at 1 |
| last_in_unit | BIGINT | Indicates if this is the last packet in the slice/unit |
| | | 0 = no, 1 = yes |
| type | BIGINT | The data type of the unit |
| | | 0 unknown |
| | | For video 1 = intra 2 = inter |
| importance | BIGINT | Assigned relative importance information |
| | | (higher number means higher importance) |

In some embodiments of the present disclosure, the service data adaptation protocol (SDAP) may support a quality of service (QOS) flow-to-data radio bearer (DRB) mapping rule, in which each QoS flow can only be mapped to one corresponding DRB and logical channel (LCH), which means that packets with different importance levels of a QoS flow may be mapped to the same DRB and LCH. However, a radio resource control (RRC) layer may control the scheduling by signaling each LCH with a corresponding “priority” parameter. For example, the higher a priority value of an LCH, the lower priority level of the LCH. In this scenario, some issues may arise when the XR traffic experiences data processing in a lower protocol layer, such as the layer 2 (L2) protocol, SDAP or medium access control (MAC).

Embodiments of the present disclosure provide solutions for data processing of XR traffic. In some embodiments, when the XR traffic with different importance levels is mapped to the same LCH/DRB, solutions for guaranteeing scheduling fairness, scheduling priority or both of the XR traffic with different importance levels are provided. For example, solutions for reflecting the importance parameter of the XR traffic are provided. For example, solutions for handling the packet with a relatively higher important level are provided. In some embodiments, solutions for avoiding the XR traffic with different importance levels to be mapped to the same LCH/DRB are provided. More details on the embodiments of the present disclosure will be illustrated in the following text in combination with the appended drawings.

In some embodiments of the present disclosure, to guarantee scheduling fairness, scheduling priority or both of the XR traffic, the importance parameter of XR traffic may be reflected in the buffer status reporting (BSR). For example, solutions for triggering a BSR for XR traffic with a high importance level and solutions for informing a BS of the importance level information in the UL buffer of a UE will be described below.

A UE may use a BSR procedure to provide the serving BS with information about the UL data volume in the MAC entity of the UE. The UE may trigger a BSR when a trigger condition is satisfied. In some embodiments of the present disclosure, the trigger condition (or criterion) for a BSR may take the importance level into consideration. For example, when a UE detects uplink data with an importance level becoming available to the MAC entity of the UE, the UE may trigger a BSR in response to the importance level satisfying a trigger condition for a BSR.

For instance, the BSR may be triggered when UL data, for an LCH which belongs to an LCH group (LCG) of the UE, becomes available to a MAC entity of the UE, and this UL data has a higher importance level than the importance level of any available UL data which belongs to any LCG trigger condition of the UE. For instance, the BSR may be triggered when UL data, for an LCH which belongs to an LCG of the UE, becomes available to the MAC entity, and this UL data has a higher importance level than an importance threshold. For instance, the BSR may be triggered when UL data becomes available to the MAC entity, and this UL data has a higher importance level than the importance level of any available UL data. For instance, the BSR may be triggered when UL data becomes available to the MAC entity, and this UL data has a higher importance level than an importance threshold. In some examples, the importance threshold may be configured by a BS or may be predefined, for example, in a standard(s).

As stated above, it should be understood that the “importance” level is an attribute for a packet (e.g., XR traffic), which can identify the relative importance information of the packet, and is different from the “priority” attribute for an LCH.

By adopting the above the trigger condition, when, for example, XR traffic with a higher importance becomes available, a BSR can be triggered so that the latency requirement of the XR traffic can be guaranteed.

A UE may use a BSR MAC control element (CE) to report the UL data volume of one or more LCGs of the UE or the amount of data expected to arrive at the one or more LCGs. It would be beneficial to provide the importance information in a BSR MAC CE to facilitate scheduling fairness among UEs by the BS. In some embodiments of the present disclosure, a BSR MAC CE may include an importance field, which may be used to indicate the relative importance information of the uplink data.

For example, a BSR MAC CE may indicate at least one LCG (also referred to as “reported LCG”). In some embodiments, the BSR MAC CE may include a single importance field, which may indicate the highest importance level among all available uplink data belonging to the at least one LCG.

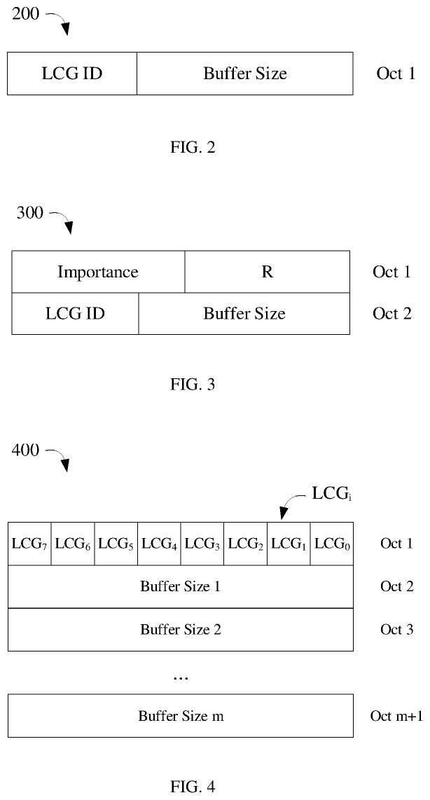

FIG. 2 illustrates an exemplary BSR MAC CE format 200 in accordance with some embodiments of the present disclosure. The BSR MAC CE format 200 is also referred to as a short BSR format or short truncated BSR format. The application scenarios of the short BSR format and short truncated BSR format are specified in 3GPP specifications. For example, when only one LCG has data available for transmission, a wireless node may choose the short BSR format to transmit the BSR. The BSR MAC CE format 200 does not take the importance level into consideration.

As shown in FIG. 2, the BSR MAC CE format 200 can be octet aligned and can include 1 byte, which can be referred to as “Oct 1” in FIG. 2. The BSR MAC CE format 200 may include several fields such as a “LCG ID” field and a “Buffer Size” field. The “LCG ID” field may identify the LCG whose buffer status is being reported. The length of this field may be 3 bits. The “Buffer Size” field may identify the amount of data available across all LCHs of the LCG identified by the “LCG ID” field. The amount of data may be indicated in units of bytes. The size of the radio link control (RLC) headers and MAC subheaders are not considered in the buffer size computation. The length of this field may be 5 bits.

FIG. 3 illustrates an exemplary BSR MAC CE format 300 in accordance with some embodiments of the present disclosure.

The BSR MAC CE format 300 is similar to BSR MAC CE format 200 except that the BSR MAC CE format 300 includes an “importance” field. The length of the “importance” field may be determined by the size of the value of the importance level (also referred to as “importance number”). In some examples, the greater the importance number, the higher the importance level; or vice versa. The “importance” field may indicate the highest importance level (e.g., the greatest importance number) among all available uplink data belonging to the LCG identified by the “LCG ID” field.

As shown in FIG. 3, the BSR MAC CE format 300 can be octet aligned and can include 2 bytes, which can be referred to as “Oct 1” to “Oct 2” in FIG. 3. The “LCG ID” field and “Buffer Size” field in FIG. 3 are similar to those in FIG. 2. The BSR MAC CE format 300 may include an “R” (“Reserved”) field which may occupy at least one bit for byte alignment.

It should be understood that BSR MAC CE format 300 is only for illustrative purposes, and should not be construed as limiting the embodiments of the present disclosure. For example, although the “importance” field is added before the “LCG ID” field in the example of FIG. 3, it should be appreciated by persons skilled in the art that the “importance” field may be positioned at any position in a BSR MAC CE format, for example, after the “LCG ID” field or “Buffer Size” field or “R” field in some other embodiments of the present disclosure.

FIG. 4 illustrates an exemplary BSR MAC CE format 400 in accordance with some embodiments of the present disclosure. The BSR MAC CE format 400 is also referred to as a long BSR format, long truncated BSR format, or pre-emptive BSR format. The application scenarios of the long BSR format, long truncated BSR format, or pre-emptive BSR format are specified in 3GPP specifications. For example, when there are more than one LCG having data available for transmission, a wireless node may choose the long BSR format to transmit the BSR. When a pre-emptive BSR is triggered at a wireless node, the wireless node may choose the pre-emptive BSR format to transmit the pre-emptive BSR.

As shown in FIG. 4, the BSR MAC CE format 400 can be octet aligned and can include m+1 byte, which can be referred to as “Oct 1” to “Oct m+1” in FIG. 4. The BSR MAC CE format 400 may include several fields such as eight “LCG;” fields (i.e., LCG₀ to LCG₇) and some “Buffer Size” fields.

For the long BSR format and pre-emptive BSR format, an “LCG;” field may indicate the presence or absence of a “Buffer Size” field for the logical channel group i (where the value of i is an integer from 0 to 7). For example, the LCG; field setting to 1 may indicate that the “Buffer Size” field for the logical channel group i is reported (i.e., included in the BSR MAC CE). The LCGᵢ field setting to 0 may indicate that the “Buffer Size” field for the logical channel group i is not reported. For the Long truncated BSR format, the “LCG;” field may indicate whether logical channel group i has data available or not. For example, the LCG; field setting to 1 may indicate that logical channel group i has data available. The LCG; field setting to 0 may indicate that logical channel group i does not have data available. For the long BSR format and long truncated BSR format, a “Buffer Size” field may identify the amount of data available across all LCHs of a corresponding LCG. The amount of data may be indicated in units of bytes. The size of the RLC headers and MAC subheaders are not considered in the buffer size computation. The length of a “Buffer Size” field for the long BSR format and the long truncated BSR format may be 8 bits. For the long truncated BSR format, the number of “Buffer Size” fields included is maximized, while not exceeding the number of padding bits.

For the long BSR format and long truncated BSR format, the “Buffer Size” fields may be included in an ascending (or descending) order based on the LCGᵢ. For example, assuming that the LCG₇, LCG₅, and LCG₃ fields indicate the “Buffer Size” fields for LCG 7, LCG 5, LCG 3 are reported, the BSR MAC CE may include three “Buffer Size” fields (e.g., Buffer Size field #7, Buffer Size field #5, and Buffer Size field #3) for LCG 7, LCG 5, LCG 3, respectively. The three “Buffer Size” fields may be arranged in an order of Buffer Size field #3, Buffer Size field #5, and Buffer Size field #7 in the BSR MAC CE (i.e., an ascending order of the IDs of the LCGs).

For the pre-emptive BSR format, the “Buffer Size” field may identify the amount of data expected to arrive at the Integrated Access and Backhaul-Mobile terminal (IAB-MT) of the node where the pre-emptive BSR is triggered and does not include the volume of data currently available in the IAB-MT. The pre-emptive BSR format may be identical to the long BSR format.

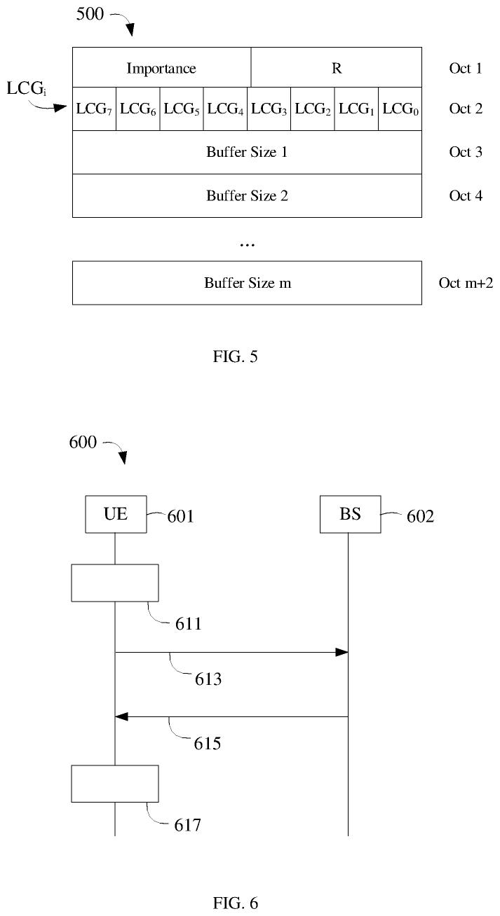

FIG. 5 illustrates an exemplary BSR MAC CE format 500 in accordance with some embodiments of the present disclosure.

The BSR MAC CE format 500 is similar to BSR MAC CE format 400 except that the BSR MAC CE format 500 includes an “importance” field. The length of the “importance” field may be determined by the size of the value of the importance level (also referred to as “importance number”). In some examples, the greater the importance number, the higher the importance level; or vice versa. The “importance” field may indicate the highest importance level (e.g., the greatest importance number) among all available uplink data belonging to the LCGs identified by the “LCGᵢ” fields (if included in the MAC CE).

As shown in FIG. 5, the BSR MAC CE format 500 can be octet aligned and can include m+2 bytes, which can be referred to as “Oct 1” to “Oct m+2” in FIG. 5. The “LCG;” fields and “Buffer Size” fields in FIG. 5 are similar to those in FIG. 4. The BSR MAC CE format 500 may include an “R” (“Reserved”) field which may occupy at least one bit for byte alignment.

It should be understood that BSR MAC CE format 500 is only for illustrative purposes, and should not be construed as limiting the embodiments of the present disclosure. For example, although the “importance” field is added before the “LCG;” fields in the example of FIG. 5, it should be appreciated by persons skilled in the art that the “importance” field may be positioned at any position in a BSR MAC CE format, for example, after all “LCG;” fields or all “Buffer Size” fields or “R” field in some other embodiments of the present disclosure.

In some embodiments, the BSR MAC CE may include a corresponding importance field for each reported LCG in the BSR MAC CE. The importance field may indicate the highest importance level among all available uplink data belonging to the corresponding LCG.

As shown above, a plurality of BSR MAC CE formats may be supported. A UE may select which BSR MAC CE format is used for the triggered BSR according to a certain criterion. In some embodiments of the present disclosure, the UE may select the BSR MAC CE format based on whether the uplink data available for transmission has an importance attribute. For example, the UE may select a BSR MAC CE format with an importance field (e.g., BSR MAC CE format 300 or BSR MAC CE format 500) in response to the uplink data available for transmission having an importance attribute. The UE may select a BSR MAC CE format without an importance field (e.g., BSR MAC CE format 200 or BSR MAC CE format 400) in response to the uplink data available for transmission not having an importance attribute.

For instance, the UE may select a BSR MAC CE format according to the following pseudo-code. The definitions of regular BSR and periodic BSR are specified in 3GPP specifications.

For Regular and Periodic BSR, the MAC entity shall:
1> if there is XR data with an importance attribute available for transmission when the MAC PDU containing the BSR is to be built:
   2> if more than one LCG has data available for transmission when the MAC PDU containing the BSR is to be built:
      3> report Long BSR with the importance field for all LCGs which have data available for transmission.
   2> or else:
      3> report Short BSR with the importance field.
1> else:
   2> if more than one LCG has data available for transmission when the MAC PDU containing the BSR is to be built:
      3> report Long BSR without the importance field for all LCGs which have data available for transmission.
   2> or else:
      3> report Short BSR without the importance field.

From the perspective of the BS, it may receive a plurality of BSRs from one or more UEs, and may schedule the one or more UEs according to the importance numbers indicated in the BSRs. For example, the BS may preferentially schedule a UE which reports a BSR with a relatively higher importance number.

In some embodiments of the present disclosure, to guarantee scheduling fairness, scheduling priority or both of the XR traffic, solutions for handling packets with importance information in a logical channel prioritization (LCP) procedure are proposed and will be described below. For example, XR traffic with high importance may be preferentially processed in a UL transmission.

In some examples, in response to receiving a BSR from a UE, a BS may allocate a UL grant to the UE so the UE can transmit uplink data buffered at the UE. In response to receiving the UL grant from the BS, the UE may perform an LCP procedure to allocate resources configured by the uplink grant to the uplink data.

In some examples, uplink data scheduling may be controlled through an RRC layer by signaling, for each logical channel per MAC entity, a “priority” where an increasing priority value indicates a lower priority level, a “prioritisedBitRate” that sets the prioritized bit rate (PBR), and a “bucketSizeDuration” that sets the bucket size duration (BSD). The MAC entity of a UE may maintain a variable Bj for each logical channel j. The variable Bj may be used in an LCP procedure to indicate the transmittable data amount of logical channel j. Bj may be initialized to zero when logical channel j is established, and incremented by the product PBR×T before every instance of the LCP procedure, where T is the time elapsed since Bj was last incremented, and the PBR is the prioritized bit rate of logical channel j. However, the value of Bj can never exceed the bucket size and if the value of Bj was greater than the bucket size of logical channel j, it would be set to the bucket size. The bucket size of a logical channel is equal to PBR×BSD, where the PBR and BSD are configured by the upper layer (e.g., the RRC layer as described above).

In some embodiments of the present disclosure, the UE may take the importance attribute of a packet (e.g., MAC service data unit (SDU) or radio link control (RLC) protocol data unit (PDU) from the MAC entity's point of view) into consideration when performing the LCP procedure.

In some embodiments of the present disclosure, the UE may preferentially consider the priority of an LCH other than the importance attribute of the packet.

For example, when a new transmission is performed at the UE, the UE may perform the LCP procedure including the following steps. At Step 1-1, the UE may (a) select an LCH with the highest priority and transmittable data amount being greater than zero (e.g., Bj>0) among all LCHs having uplink data available for transmission; (b) preferentially allocate a resource configured by the uplink grant to a data packet with an importance level in the selected LCH; and (c) in response to any resource configured by the uplink grant remaining and the transmittable data amount of the selected LCH being greater than zero (e.g., Bj>0), the UE may allocate the resource configured by the uplink grant to a data packet without an importance level in the selected LCH. In step 1-1 (b), the UE may allocate resources configured by the uplink grant to data packets with respective importance levels in the selected LCH in a decreasing importance level order. At Step 1-2, the UE may decrement the transmittable data amount of the selected LCH by the size of the data packets in the selected LCH which have been allocated with resources (e.g., as described in step 1-1). The UE may perform Step 1-1 and Step 1-2 for the remaining LCHs in a decreasing priority order.

For instance, the UE may perform the LCP procedure according to the following pseudo-code.
1> Step 1-1′: select the highest priority LCH with Bj>0 (for example, according to the method described in 3GPP specifications), prioritize to allocate a resource to the important MAC SDUs (optional, in a decreasing importance order) in this selected LCH firstly. And if any resources remain and Bj is still >0, allocate a resource to this selected LCH for other MAC SDUs without importance identification.
1> Step 1-2′: decrement Bj by the total size of MAC SDUs served to logical channel j above.
1> Continue execute Step 1-1′ and Step 1-2′ for other LCHs with Bj>0 in a decreasing priority order.
1> If any resources remain, all the logical channels selected are served in a strict decreasing priority order (regardless of the value of Bj) until either the data for that logical channel or the UL grant is exhausted, whichever comes first. Logical channels configured with equal priority should be served equally.

In some embodiments of the present disclosure, the UE may preferentially consider the importance attribute of the packet other than the priority of the LCH.

For example, when a new transmission is performed at the UE, the UE may perform the LCP procedure including the following steps. At Step 2-1, the UE may allocate resources configured by the uplink grant to data packets with respective importance levels among all LCHs in a decreasing importance level order. At Step 2-2 (optional), the UE may decrement a transmittable data amount of an LCH by the size of the data packets with the respective importance levels in the LCH which have been allocated with resources. At Step 2-3, in response to any resource configured by the uplink grant remaining, the UE may allocate the remained resources to data packets without importance levels.

For instance, the UE may perform the LCP procedure according to the following pseudo-code.
1> Step 2-1′: allocate the resources to the MAC SDUs in a decreasing importance order among all LCHs.
1> Step 2-2′ (optional): decrement Bj by the size of MAC SDUs for each logical channel in which MAC SDUs are associated
1> Step 2-3′: if any resources remain, perform the following procedure for the MAC SDUs without importance identification:
   2> logical channels selected according to the 3GPP specification for the UL grant with Bj>0 are allocated resources in a decreasing priority order. If the PBR of a logical channel is set to infinity, the MAC entity shall allocate resources for all the data that is available for transmission on the logical channel before reaching the PBR of the lower priority logical channel(s);
   2> decrement Bj by the total size of MAC SDUs served to logical channel j above;
   2> if any resources remain, all the logical channels selected according to the 3GPP specification are served in a strict decreasing priority order (regardless of the value of Bj) until either the data for that logical channel or the UL grant is exhausted, whichever comes first. Logical channels configured with equal priority should be served equally.

In some embodiments of the present disclosure, solutions for avoiding traffic with different importance levels to be mapped to the same LCH/DRB are provided. In some examples, a QoS flow-to-DRB mapping rule is introduced to achieve this goal. The QoS flow-to-DRB mapping rule may map a QoS flow to at least one DRB (e.g., more than one DRB). The QoS flow-to-DRB mapping rule may be configured for a UE by a BS via, for example, RRC signaling. The UE may map an uplink packet for a certain QoS flow to a corresponding DRB according to the QoS flow-to-DRB mapping rule. For example, in response to the reception of a service data adaptation protocol (SDAP) SDU from an upper layer for a QoS flow, the transmitting SDAP entity may map the SDAP SDU to a corresponding DRB according to the configured QoS flow-to-DRB mapping rule.

For example, UL packets within the same QoS flow may have different importance levels. That is, a QoS flow (for example, QoS flow #A) may be associated with a plurality of importance levels. The QoS flow-to-DRB mapping rule may map QoS flows to DRBs according to importance levels associated with the QoS flows. For example, instead of mapping all packets within QoS flow #A to a single DRB, the QoS flow-to-DRB mapping rule may map the packets with different importance levels to different DRBs. That is, different importance levels associated with QoS flow #A may be mapped to different DRBs. For example, the QoS flow-to-DRB mapping rule may map the same importance level associated with different QoS flows to the same DRB. For example, the QoS flow-to-DRB mapping rule may map each importance level associated with a specific QoS flow to only one respective DRB.

In some examples, a QoS flow ID (QFI) may be employed to identify a QoS flow. The QFI may be unique within a PDU session, which may have a plurality of QoS flows (e.g., 64 QoS flows). The QFI may not be unique among different PDU sessions. For example, the same QFI may be used to identify different QoS flows for different PDU sessions. According to the above QoS flow-to-DRB mapping rule, a QFI (corresponding to a QoS flow) may be mapped to at least one DRB (e.g., two or more DRB), and different importance numbers of a QFI (e.g., within one PDU-session) may be mapped to different DRBs. For example, QFI #1 (e.g., corresponding to QoS flow #1) importance #1 and QFI #1 importance #2 may be mapped to DRB #1 while QFI #1 importance #3 may be mapped to DRB #2.

Table 2 below shows an exemplary QoS flow-to-DRB mapping rule.

TABLE 2
QoS flow-to-DRB mapping rule

| | |
|---|---|
| QFI #1 importance #1 | DRB #1 |
| QFI #1 importance #2 | DRB #1 |
| QFI #1 importance #3 | DRB #2 |
| QFI #2 importance #1 | DRB #3 |
| QFI #2 importance #2 | DRB #4 |
| QFI #2 importance #3 | DRB #4 |
| QFI #3 importance #1 | DRB #1 |
| QFI #3 importance #2 | DRB #1 |

It should be understood that Table 2 is only for illustrative purposes, and should not be construed as limiting the embodiments of the present disclosure. From a signaling design point of view, it is supposed to configure the associated QFI and importance with DRB configuration. For example, an importance number(s) for each and every QFI may be mapped to a corresponding DRB(s).

In addition, each importance number of each QFI (e.g., within the same PDU-session) can be only mapped to one respective DRB. For example, each importance number of each QFI (e.g., within the same PDU-session) may be included at most once in all configured instances of an SDAP configuration (e.g., sdap-Config for a DRB as specified in 3GPP specifications) with the same PDU session ID (e.g., pdu-Session as specified in 3GPP specifications). That is, the QoS flow-to-DRB mapping rule may be added or released per importance number of a QFI.

FIG. 6 illustrates a flow chart of an exemplary procedure 600 of wireless communications in accordance with some embodiments of the present disclosure. Details described in all of the foregoing embodiments of the present disclosure are applicable for the embodiments shown in FIG. 6.

Referring to FIG. 6, in operation 611, UE 601 may detect uplink data with an importance level becoming available to the MAC entity of UE 601. The importance level may identify the relative importance information of the uplink data. The uplink data may be associated with a logical channel belonging to an LCG of UE 601.

UE 601 may trigger a BSR in response to the importance level satisfying a criterion for triggering a BSR. In some examples, the UE may determine that the importance level satisfies the criterion for triggering the BSR in response to the importance level being higher than the importance level of any available uplink data in the MAC entity of the UE, or the importance level being higher than an importance threshold. The importance threshold may be configured by a BS (e.g., BS 602) or may be predefined.

In operation 613, UE 601 may transmit a BSR MAC CE to BS 602 in response to triggering the BSR. The BSR MAC CE may include an importance field. The importance field may indicate the relative importance information. In some examples, the BSR MAC CE may have a format as described with respect to one of FIGS. 3 and 5.

For example, the BSR MAC CE may indicate at least one LCG, and the importance field may indicate the highest importance level among all available uplink data belonging to the at least one LCG. For example, the BSR MAC CE indicates at least one LCG, and for each LCG of the at least one LCG, the BSR MAC CE may include a corresponding importance field, which may indicate the highest importance level among all available uplink data belonging to the corresponding LCG.

In some examples, the UE may select a BSR MAC CE format with an importance field in response to uplink data available for transmission having an importance attribute. For instance, in the example of FIG. 6, UE 601 may detect uplink data with an importance level, so UE 601 may select a BSR MAC CE format with an importance field. In some examples, the UE may select a BSR MAC CE format without an importance field in response to uplink data available for transmission not having an importance attribute.

In operation 615, in response to the reception of the BSR MAC CE, BS 602 may transmit an uplink grant to UE 601 based on the importance field of the BSR MAC CE. In some examples, transmitting the uplink grant based on the importance field of the BSR MAC CE may include preferentially transmitting the uplink grant to UE 601 in response to the importance field indicates an importance level higher than that of another BSR MAC CE.

Accordingly, UE 601 may receive the uplink grant for transmitting uplink data buffered at the UE in response to the BSR. In operation 617, UE 601 may perform an LCP procedure to allocate resources configured by the uplink grant to the uplink data. In some examples, UE 601 may perform the LCP procedure as described above.

In an example, UE 601 may (a) select a logical channel (LCH) with a highest priority and transmittable data amount (e.g., Bj) being greater than zero among all LCHs having uplink data available for transmission; and (b) preferentially allocate a resource configured by the uplink grant to a data packet with an importance level in the selected LCH. For instance, to allocate a resource to a data packet with an importance level in the selected LCH, the UE may allocate resources configured by the uplink grant to data packets with respective importance levels in a decreasing importance level order. UE 601 may further (c) in response to any resource configured by the uplink grant remaining and the transmittable data amount of the selected LCH being greater than zero, allocate a resource configured by the uplink grant to a data packet without an importance level in the selected LCH. UE 601 may further (d) decrement the transmittable data amount of the selected LCH by the size of the data packets in the selected LCH which have been allocated with resources; and perform steps (a)-(d) for remaining LCHs in a decreasing priority order.

In another example, UE 601 may allocate resources configured by the uplink grant to data packets with respective importance levels among all LCHs in a decreasing importance level order. In some examples, UE 601 may (optionally) decrement a transmittable data amount of an LCH by the size of the data packets with the respective importance levels in the LCH which have been allocated with resources.

It should be appreciated by persons skilled in the art that the sequence of the operations in exemplary procedure 600 may be changed and some of the operations in exemplary procedure 600 may be eliminated or modified, without departing from the spirit and scope of the disclosure.

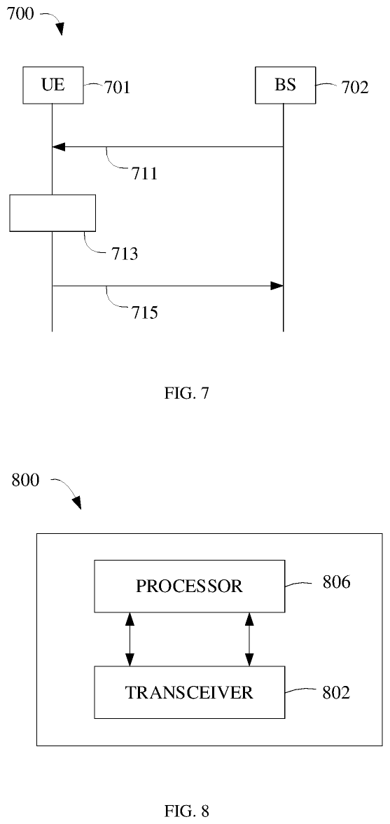

FIG. 7 illustrates a flow chart of an exemplary procedure 700 of wireless communications in accordance with some embodiments of the present disclosure. Details described in all of the foregoing embodiments of the present disclosure are applicable for the embodiments shown in FIG. 7.

Referring to FIG. 7, in operation 711, UE 701 may receive an RRC message configuring a QoS flow-to-DRB mapping rule. The QoS flow-to-DRB mapping rule may be configured according to the principles as described above. For example, the mapping rule may map a first QoS flow to at least one DRB (e.g., two or more DRBs).

For example, the mapping rule may map QoS flows to DRBs according to importance levels associated with the QoS flows. For example, the mapping rule may map a first importance level and a second importance level associated with the first QoS flow to different DRBs of the at least one DRB. For example, the mapping rule may map each importance level associated with the first QoS flow to only one respective DRB of the at least one DRB. For example, the mapping rule may map the same importance level associated with different QoS flows to the same DRB of the at least one DRB.

In operation 713, UE 701 may map an uplink packet for the first QoS flow to a DRB according to the mapping rule. In operation 715, BS 702 may receive an uplink packet for the first QoS flow according to the mapping rule.

It should be appreciated by persons skilled in the art that the sequence of the operations in exemplary procedure 700 may be changed and some of the operations in exemplary procedure 700 may be eliminated or modified, without departing from the spirit and scope of the disclosure.

FIG. 8 illustrates a block diagram of an exemplary apparatus 800 according to some embodiments of the present disclosure. As shown in FIG. 8, the apparatus 800 may include at least one processor 806 and at least one transceiver 802 coupled to the processor 806. The apparatus 800 may be a UE or a BS.

Although in this figure, elements such as the at least one transceiver 802 and processor 806 are described in the singular, the plural is contemplated unless a limitation to the singular is explicitly stated. In some embodiments of the present application, the transceiver 802 may be divided into two devices, such as a receiving circuitry and a transmitting circuitry. In some embodiments of the present application, the apparatus 800 may further include an input device, a memory, and/or other components.

In some embodiments of the present application, the apparatus 800 may be a UE. The transceiver 802 and the processor 806 may interact with each other so as to perform the operations with respect to the UE described in FIGS. 1-7. In some embodiments of the present application, the apparatus 800 may be a BS. The transceiver 802 and the processor 806 may interact with each other so as to perform the operations with respect to the BS described in FIGS. 1-7.

In some embodiments of the present application, the apparatus 800 may further include at least one non-transitory computer-readable medium.

For example, in some embodiments of the present disclosure, the non-transitory computer-readable medium may have stored thereon computer-executable instructions to cause the processor 806 to implement a method(s) with respect to the UE(s) as described above. For example, the computer-executable instructions, when executed, cause the processor 806 interacting with transceiver 802 to perform the operations with respect to the UE described in FIGS. 1-7.

In some embodiments of the present disclosure, the non-transitory computer-readable medium may have stored thereon computer-executable instructions to cause the processor 806 to implement a method(s) with respect to the BS as described above. For example, the computer-executable instructions, when executed, cause the processor 806 interacting with transceiver 802 to perform the operations with respect to the BS described in FIGS. 1-7.

Those having ordinary skill in the art would understand that the operations or steps of a method(s) described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
detect an uplink data with a first importance level becoming available to a medium access control (MAC) entity of the UE, wherein the first importance level identifies a relative importance of the uplink data; and
trigger buffer status reporting (BSR) based on the uplink data.

2. The UE of claim 1, wherein the at least one processor is configured to cause the UE to trigger the BSR in response to the first importance level being higher than the importance level of any available uplink data in the MAC entity of the UE, or the first importance level being higher than an importance level threshold.

3. The UE of claim 2, wherein the importance level threshold is configured by a base station (BS) or is predefined.

4. The UE of claim 1, wherein the at least one processor is configured to cause the UE to:
transmit a BSR MAC control element (CE) in response to triggering the BSR, wherein the BSR MAC CE includes an importance field.

5. The UE of claim 4, wherein the BSR MAC CE indicates at least one logical channel group (LCG), and the importance field indicates the highest importance level among all available uplink data belonging to the at least one LCG.

6. The UE of claim 4, wherein the BSR MAC CE indicates at least one logical channel group (LCG), and wherein for each LCG of the at least one LCG, the BSR MAC CE includes a corresponding importance field, which indicates the highest importance level among all available uplink data belonging to the corresponding LCG.

7. The UE of claim 1, wherein the at least one processor is configured to cause the UE to perform at least one of:
select a BSR MAC control element (CE) format with an importance field in response to uplink data available for transmission having an importance attribute; or
select a BSR MAC CE format without an importance field in response to uplink data available for transmission not having an importance attribute.

8. The UE of claim 1, wherein the at least one processor is configured to cause the UE to receive an uplink grant for transmitting uplink data buffered at the UE in response to the BSR; and
wherein the at least one processor is configured to cause the UE to perform a logical channel prioritization (LCP) procedure to allocate resources configured by the uplink grant to the uplink data.

9. The UE of claim 8, wherein to perform the LCP procedure, the at least one processor is configured to cause the UE to:
select a logical channel (LCH) with a highest priority and transmittable data amount being greater than zero among all LCHs having uplink data available for transmission; and
preferentially allocate a resource configured by the uplink grant to a data packet with an importance level in the selected LCH.

10. The UE of claim 8, wherein to perform the LCP procedure, the at least one processor is configured to cause the UE to:
allocate resources configured by the uplink grant to data packets with respective importance levels among all logical channels (LCHs) in a decreasing importance level order.

11. A base station (BS), comprising:
at least one memory; and
at least one processor coupled with the at least one memory and configured to cause the base station to:
receive, from a user equipment (UE), buffer status reporting (BSR), wherein the BSR includes an importance field; and
transmit an uplink grant to the UE based on the importance field of the BSR.

12. The BS of claim 11, wherein the at least one processor is configured to cause the BS to transmit, to the UE, an importance level threshold for triggering a BSR.

13. The BS of claim 11, wherein the BSR indicates at least one logical channel group (LCG) of the UE, and the importance field indicates the highest importance level among available uplink data belonging to the at least one LCG.

14. The BS of claim 11, wherein the BSR indicates at least one logical channel group (LCG) of the UE, and wherein for each LCG of the at least one LCG, the BSR includes a corresponding importance field, which indicates the highest importance level among available uplink data belonging to the corresponding LCG.

15. The BS of claim 11, wherein transmitting the uplink grant to the UE based on the importance field of the BSR comprises preferentially transmitting the uplink grant to the UE in response to the importance field indicates a importance level higher than that of another BSR.

16. A processor for wireless communication, comprising:
at least one controller coupled with at least one memory and configured to cause the processor to:
detect an uplink data with a first importance level becoming available to a medium access control (MAC) entity of the processor, wherein the first importance level identifies a relative importance of the uplink data; and
trigger buffer status reporting (BSR) based on the uplink data.

17. The processor of claim 16, wherein the at least one controller is configured to cause the processor to trigger the BSR in response to the first importance level being higher than the importance level of any available uplink data in the MAC entity of the processor, or the first importance level being higher than an importance level threshold.

18. The processor of claim 17, wherein the importance level threshold is configured by a base station (BS) or is predefined.

19. The processor of claim 16, wherein the at least one controller is configured to cause the processor to:
transmit a BSR MAC control element (CE) in response to triggering the BSR, wherein the BSR MAC CE includes an importance field.

20. A method performed by a user equipment (UE), the method comprising:
detecting an uplink data with a first importance level becoming available to a medium access control (MAC) entity of the UE, wherein the first importance level identifies a relative importance of the uplink data; and
triggering buffer status reporting (BSR) based on the uplink data.
